(19) United States
(12) Patent Application Publication
(10) Pub. No.: US 2016/0192634 A1
(43) Pub. Date: Jul. 7, 2016

(54) FLEXIBLE EQUID SHOE AND MANUFACTURING PROCESS

(71) Applicant: Elif BASIC, (US)

(72) Inventor: Elif Husniye BASIC, Cornaux (CH)

(21) Appl. No.: 14/787,535

(22) PCT Filed: Feb. 24, 2014
(86) PCT No.: PCT/CH2014/000024

§ 371 Date: Mar. 11, 2016

(30) Foreign Application Priority Data
Apr. 29, 2013 (CH) 882/13

(51) Int. Cl. A01L 3/04; A01L 5/00; A01L 1/04

(52) U.S. Cl. CPC A01L 3/04; A01L 1/04; A01L 5/00

(57) ABSTRACT

The present invention concerns a flexible horseshoe, of hybrid composition, and the method for producing same. This shoe provides for the natural mobility of the foot of the horse while offering it protection and ensuring the integrity of the structures of same. This shoe protects against wear, is thin, shock absorbing, light, comfortable, economical, easy to produce and easy to fix to the hoof. This shoe comprises at least two stacked layers: an upper layer made from a red elastomer material, or another potentially fluorescent colour, with a granular surface constructed in such a way as to ensure perfect contact with the hoof; and a lower layer made from a rigid material intended to come into contact with the ground, consisting of two lateral portions joined at the central portion by a hinge.

### REFERENCE DATA

The present application is based on international application WO2014/CH00024 filed on Feb. 24, 2014, the contents of which is hereby enclosed by reference. It claims priority from Swiss patent application CH2013/000882 filed on Apr. 29, 2013, the contents of which is hereby enclosed by reference.

### FIELD OF THE INVENTION

This invention concerns a shoe for equid animals. Specifically, this may be a horseshoe.

The invention also relates to a method for manufacturing this shoe.

### BACKGROUND TO THE INVENTION

The horseshoe is a metal strip bent into a U-shape that serves to protect the underside of the hooves of equine animals from wear.

The origin of the horseshoe is very controversial; it is assumed that it was invented by the Gauls and perhaps even the Celts before them. Horseshoes were unknown in ancient Greece, as is seen by their absence on horse sculptures in the Parthenon. Written documents on the horse gathered in certain Greek volumes dating from 500 BC place emphasis on the need to harden the hoof and mention embatai, a kind of leather sandal laced to the feet of some horses.

Roman writers described only hipposandals, iron shoes which were attached but not nailed to the foot of the horse by a strap fastened tightly to the pastern. What is not disputed is that a shoe similar to the Gallic shoe, a shoe capable of being nailed, proliferated and was popularised in Gallo-Roman times, and then among the Franks and Merovingians.

Thereafter, the horseshoe was of the Crecy type, which was to evolve little until the 15^{th} century.

In the 16^{th} century, toe clips made a brief appearance and horses were still being cold shod.

In the 18^{th} century, the horseshoe as we know it today was developed.

In the 20^{th} century, the rise of the metallurgical industry was to provide the option of using metals that were lighter or more suited to the work of horses and thus contribute to sports and leisure riding.

In Arab countries, particularly in Egypt, donkeys and mules were sometimes shod.

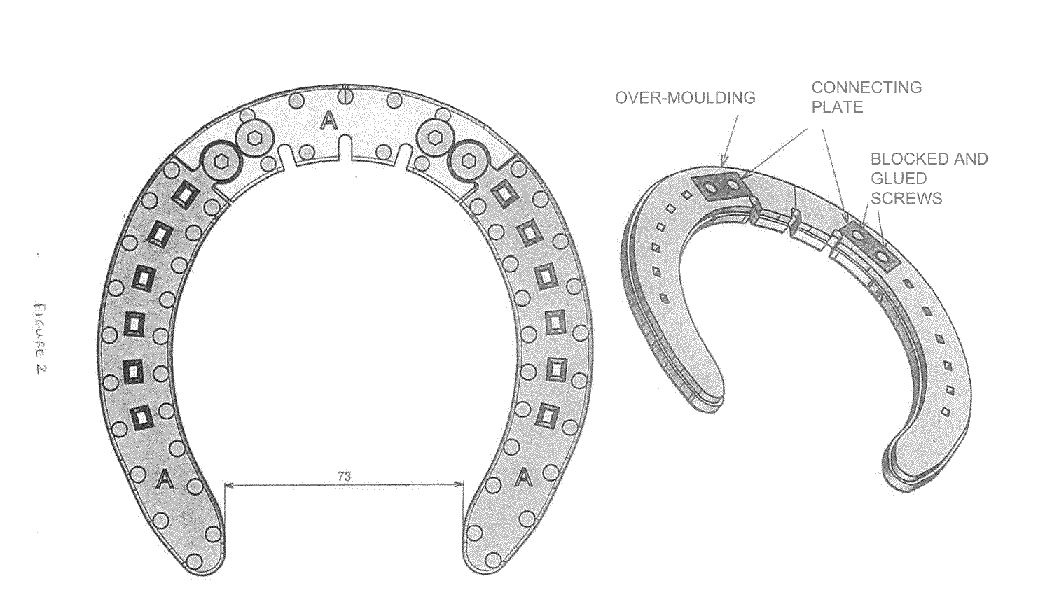

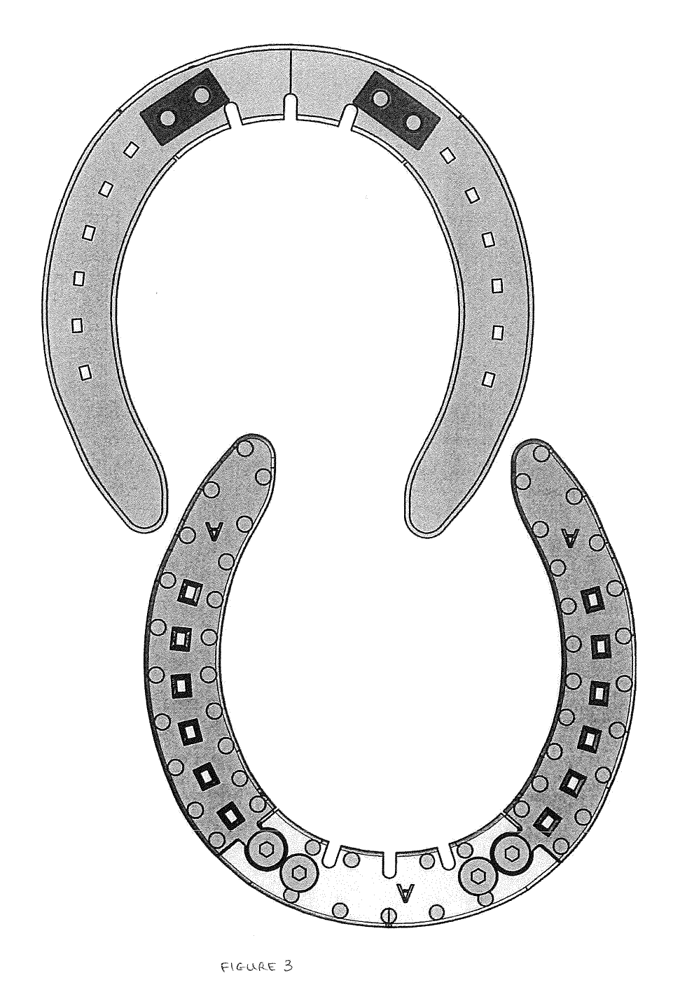

There are many technical documents on the subject of the horseshoe. Among these, one of the most recent is the international patent application published under number WO2004/023871 which, with reference to FIGS. 2 and 3, describes a horseshoe with a composite structure made up of three layers, namely, an upper polyurethane layer, a central layer of aluminium alloy and a lower layer of polyurethane (see page 4, lines 13 to 23).

The main problem with horseshoes known to date is that they impede the dynamics of the horse's foot.

### SUMMARY PRESENTATION OF THE INVENTION

The purpose of the invention is to propose an equid shoe that above all respects the integrity of the biomechanics while protecting against wear, is thin, shock absorbing, lightweight, comfortable for the animal wearing it, inexpensive, simple to manufacture and easy to attach to the animal's hoof.

This purpose is achieved by this invention by way of an equid shoe comprising at least two overlapping layers, at least one of which is made of a rigid material and at least one of an elastomeric material, and is characterised by the fact that it includes:
an upper layer of a red or fluorescent yellow tinted elastomeric material, with a granular surface, developed so as to ensure complete contact with the hoof of the animal
a lower layer of rigid material intended to come into contact with the ground

This equid shoe has the remarkable advantage of retaining all the dynamics of the horse's foot. Indeed, it has an elasticity that is not detrimental to what specialists call the “pump phenomenon”, thus allowing an almost natural continuation of mechanics while ensuring the integrity of the wall of the horse's foot.

In particular, because of its hybrid composition, this equid shoe has the advantage of reducing mass by 50%, generating much less stress on the distal joints of the horse.

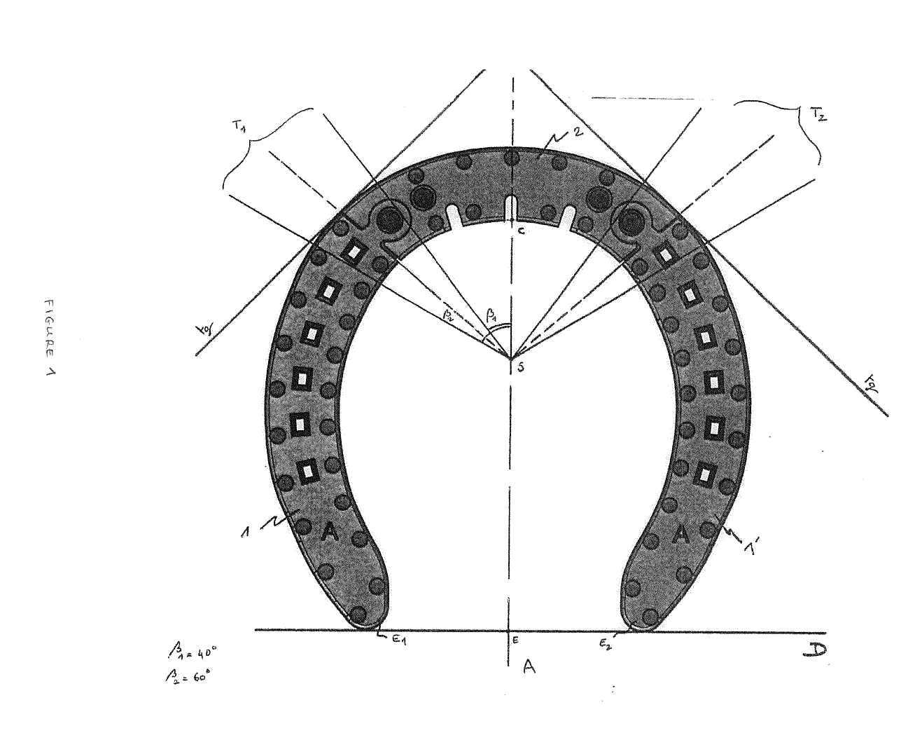

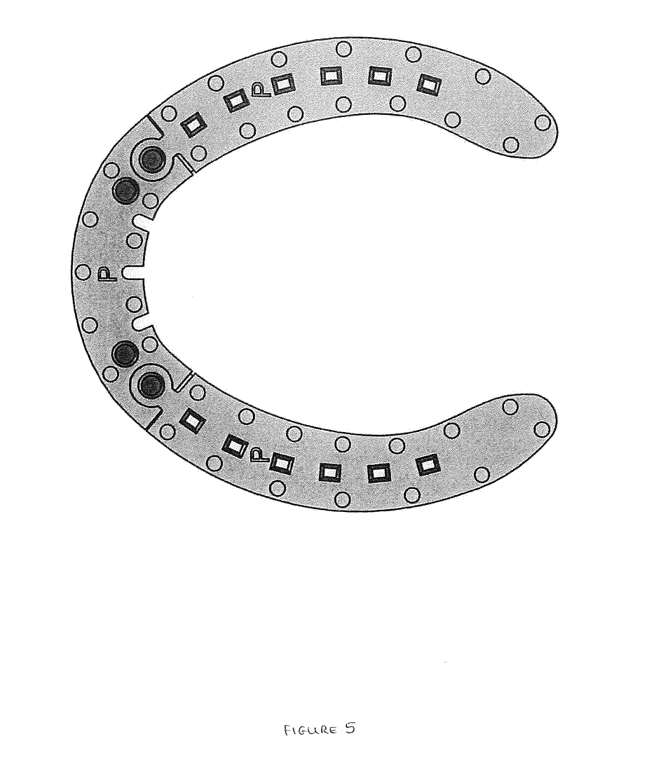

The invention also relates to a manufacturing process for such a shoe, comprising the following stages:
three inserts constituting the lower part of the equid shoe are cut out of a sheet of rigid material, these inserts having different shapes (see FIGS. 1 and 5) and substantially the same thickness
the inserts are over-moulded by injecting the upper layer with elastomeric material, with this layer having substantially the same shape and covering the entirety of the inserts of the lower part but, in general, having a substantially different thickness in comparison with that of the inserts of the lower part (see FIGS. 2, 3, 6 and 7)

Other features and advantages of the invention will now be described in detail in the following presentation, which is given with reference to the diagrams attached in annex which show schematically:

FIG. 1: an equid shoe, created in accordance with the invention, front hoof design, bottom view

FIG. 2: an equid shoe, created in accordance with the invention, front hoof design, bottom view and ¾ in 3D of the elastomer part

FIG. 3: an equid shoe, created in accordance with the invention, front hoof design, bottom view and top view

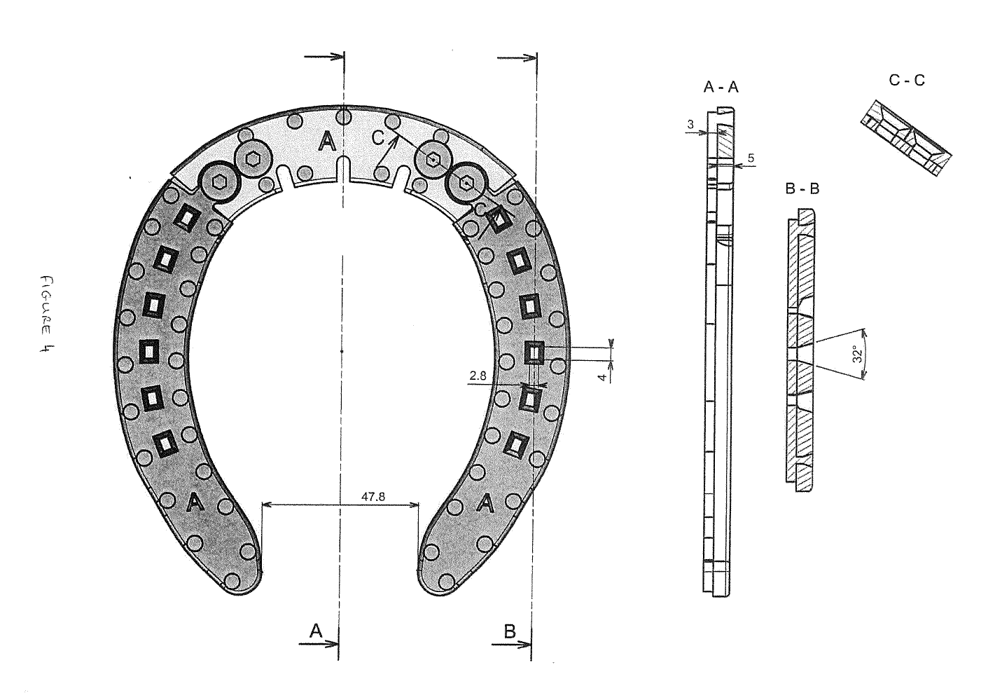

FIG. 4: an equid shoe, created in accordance with the invention, front hoof design, closed position, bottom view, sectional view and hinge in sectional view

FIG. 5: an equid shoe created in accordance with the invention, rear hoof design, bottom view

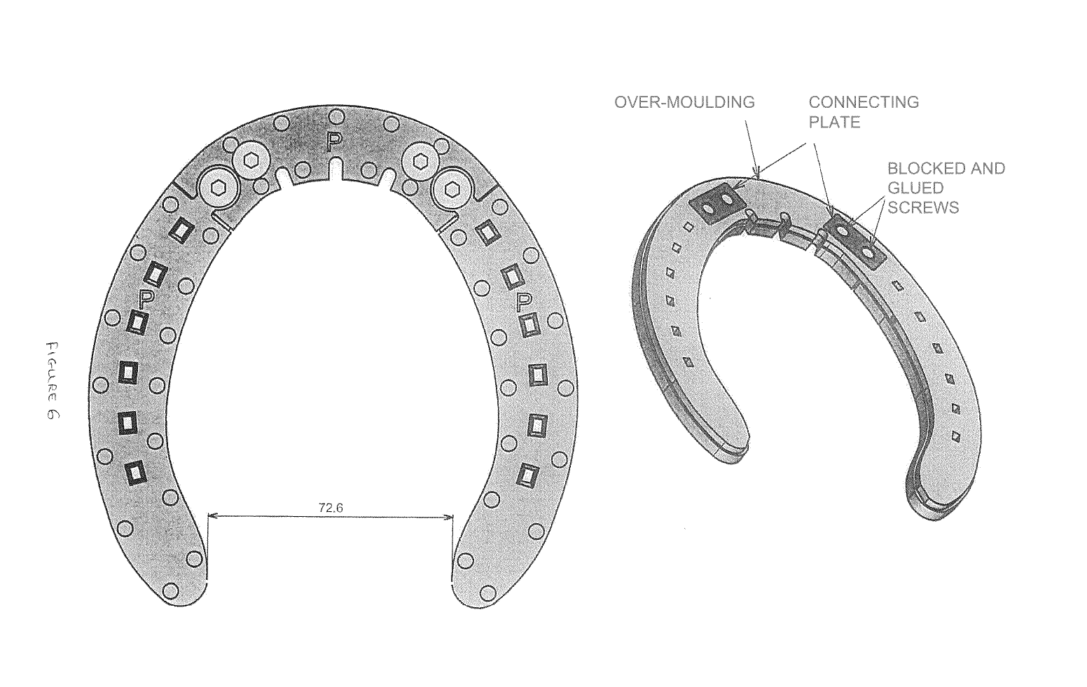

FIG. 6: an equid shoe created in accordance with the invention, front hoof design, bottom view and ¾ in 3D of the elastomer part

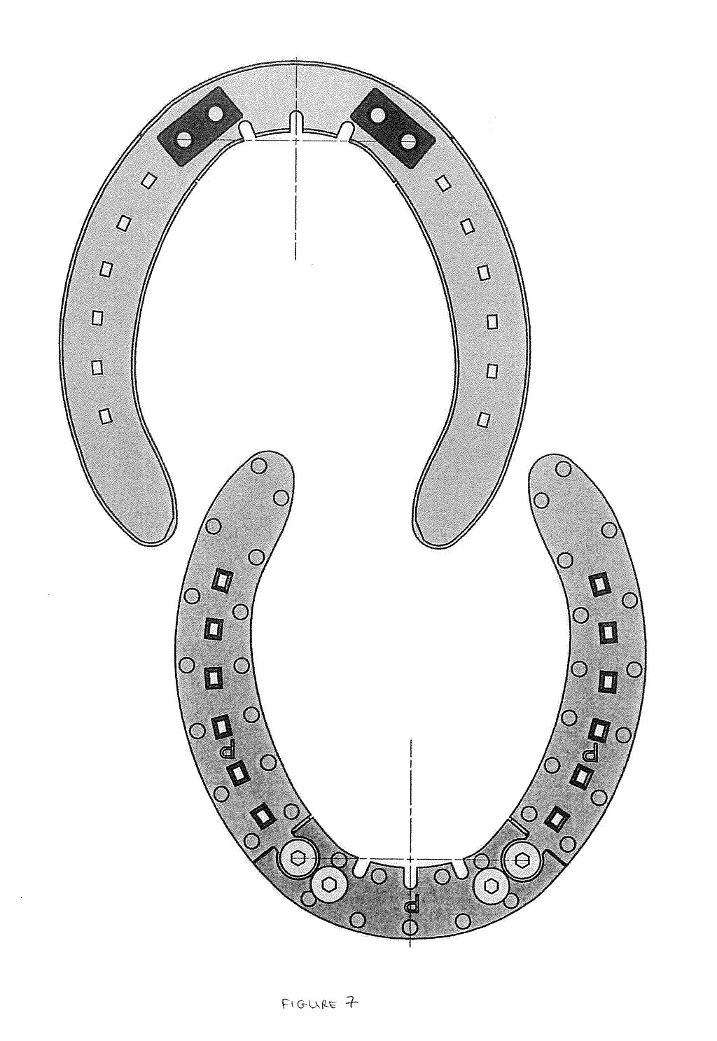

FIG. 7: an equid shoe created in accordance with the invention, rear hoof design, bottom view and top view

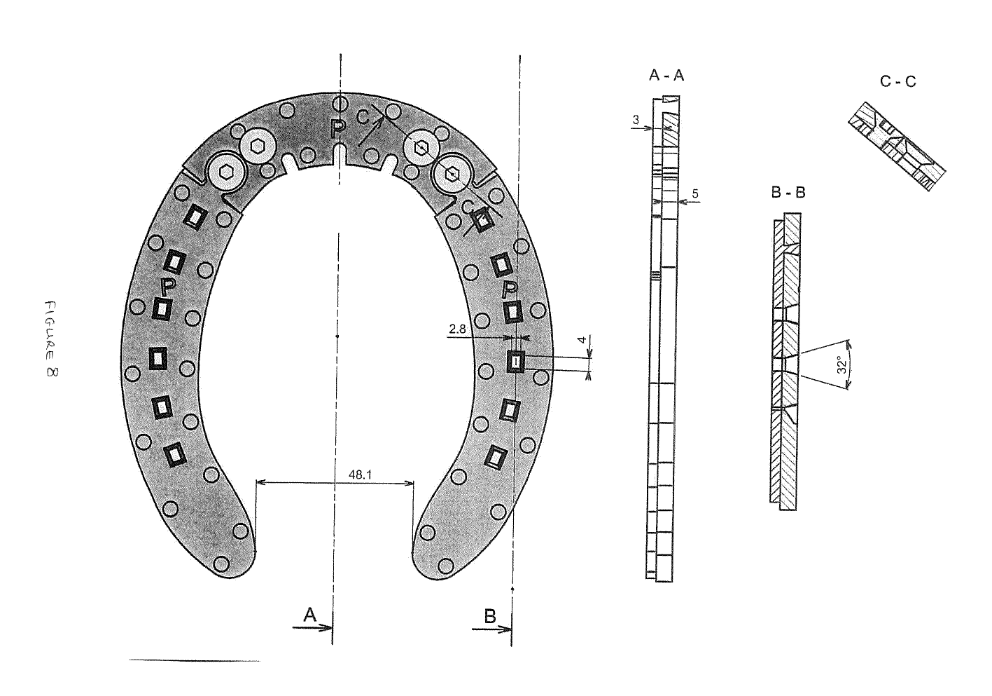

FIG. 8: an equid shoe created in accordance with the invention, rear hoof design, closed position, bottom view, sectional view, and hinge in sectional view

### DETAILED PRESENTATION OF THE INVENTION

An example of the creation of an equid shoe made in accordance with the invention will now be given for illustrative and non-exhaustive purposes.

In FIGS. 1 and 5, the equid shoe created according to the invention has the shape of a horseshoe, that is to say it is substantially U-shaped.

This horseshoe has three parts, two lateral parts symmetrical with respect to the symmetry axis A and a central part.

As can be seen in FIGS. 2 and 6, the horseshoe has at least two overlapping layers, namely:
an upper layer with a red tint or other potentially fluorescent colour, with a granular surface, developed so as to ensure complete contact with the hoof of the animal
a lower layer of rigid material intended to come into contact with the ground
at least three indentations on the rigid part on the lower underside: the first on symmetry axis A, the second and third symmetrically perpendicular with respect to the shoe's tangential axis according to angles equivalent to β1 and β2 located between 40 and 60 degrees with respect to the symmetry axis of the shoe.

The rigid material therefore provides strength and durability, and the elastomeric material has the effect of elasticity and vibration damping and isolation in terms of heat conductivity (due to the friction of the rigid part on the ground).

A favorable realization of the invention seen in FIG. 1, shows the lower layer consisting of two lateral parts joined to the central part by a hinge (see FIGS. 4 and 8). Its axis can support considerable weight giving the equid shoe lateral movement while allowing maintenance of perfect integrity of the lining. This spacing of lateral parts 1 and 1′ with respect to one another symmetrically with respect to the central axis of the shoe is at least 0.5 cm from symmetry axis A for each of lateral parts 1 and 1′, innovatively respecting the natural spacing movement of the horse's foot.

Returning to FIGS. 4 and 8 with a sectional view of the hinge, it can be seen that it is preferable that it is this form for ensuring a perfect fit over time and, with the gradual wear of the lower rigid part in contact with the ground, maintaining the integrity of the mechanism so as not to cause a tearing effect between the lateral parts 1 and 1′ and the central part 2. In addition, it is desirable that these two hinges joining the lateral parts 1 and 1′ to the central part 2 are positioned symmetrically with respect to the symmetry axis A of the shoe and substantially perpendicular to the tangent of the periphery of the shoe. In accordance with a proper realisation of the invention as seen in FIG. 4, the two hinges are included in segments T1 and T2 of the shoe formed by the area common to angles β1 and β2. These angles are formed from symmetry axis A from the side of point C at the intersection of symmetry axis A and the internal periphery of the shoe and they have a common vertex S located mid-distance between point C and point E at the intersection of symmetry axis A and the straight line D connecting the ends E1 and E2 of the parts of the shoe.

Angles β1 and β2 are generally from 40 to 60 degrees and are preferably 50 degrees.

The elastomeric upper layer adheres to the lower part by a process of injecting into holes previously made in the lower part (see FIGS. 4 and 8). The role of this layer is to ensure the elasticity of the movement of the hinge, biotechnologically respecting the movement of the foot.

By way of example, the elastomeric upper layer may have a thickness generally comprising between 3 and 5 mm from the base to the vertex of the granulation. It is preferably about 4 mm.

The lower layer may have a thickness of 3 to 6 mm and is preferably about 5 mm.

It therefore appears that the equid shoe produced in accordance with the invention is thin, because it is generally less than 1 cm. This is particularly interesting because when there is minimal thickness, the pump phenomenon can take place. Indeed, in the field of equestrian sports, especially racing, there is a current tendency to unshoe horses, which has the aim of giving the horses' feet all their dynamism and therefore better performance.

As regards the materials of the equid shoe, in accordance with the invention, the lower layer can be any suitable rigid material, for example, a metal such as iron, titanium or aluminium or a metal alloy, such as steel or an aluminium alloy.

The material constituting the upper layer can be any suitable thermoplastic material; polyurethanes can be cited as an example.

A beneficial feature of the invention is that the equid shoe has extensions on the elastomeric upper layer, designated toe clips, to a maximum of 6. These play a role of optimising the grip of the shoe to the horse's foot.

The elastomeric upper part will also feature a housing for the insertion of an electronic sensor on the part designated the clamp.

### Manufacturing Process

To manufacture the equid shoe in accordance with the invention, proceed as follows:
three inserts constituting the lower part of the equid shoe are cut out of a sheet of rigid material, these inserts having different shapes (see FIGS. 1 and 5) and substantially the same thickness
the inserts are over-moulded by injecting the upper layer with elastomeric material, with this layer having substantially the same shape and covering the entirety of the inserts of the lower part but, in general, having a substantially different thickness in comparison with that of the inserts of the lower part (see FIGS. 2, 3, 6 and 7)

The fixing is carried out by any suitable means, for example by riveting or adhesive bonding.

To facilitate riveting, a maximum of 14 fixing holes or nail holes are made on the rigid part (see FIGS. 1 and 5). The nail holes mainly used appear after injection on the upper part without filling of elastomeric material.

### Use

The equid shoe, made in accordance with the invention, may be attached to the front and/or rear legs of the animal. In principle, an even number of shoes is fixed, that is to say, either two front, two rear or all four limbs.

The fixing can be done in the usual manner with nails inserted into the holes or nail holes or by adhesive bonding gluing, with the assistance in particular of a suitable resinous glue having the advantage of best respecting the biomechanical qualities of the horse's foot.

The equid shoe made in accordance with the invention can be used for any sporting event thanks to its lightness and its non-restrictive character for the animal wearing it. It allows the latter to optimise performance while protecting the integrity of its foot and preserving its natural biomechanical qualities.

1. Equid shoes, particularly horseshoes, comprising at least two overlapping layers, at least one of which is made of a rigid material and at least one of an elastomeric material, and comprising:
an upper layer of an elastomeric material having a granular surface produced so as to ensure complete contact with the shoe of the equid animal, and
a lower layer of a rigid material intended to come into contact with the ground.

2. The equid shoe of claim 1, wherein the top layer of elastomer material has on its surface a granular structure with an adherent shape intended to improve contact with the animal's hoof and a maximum of 6 toe clips arranged symmetrically with respect to symmetry axis also intended to improve contact with the hoof of the equid.

3. The equid shoe of claim 1, wherein the lower rigid layer intended to come into contact with the ground comprises two hinges arranged symmetrically with respect to the symmetry axis and connecting the lateral parts to a central part of the lower rigid layer.

4. The equid shoe of claim 3, wherein the hinges are included in an area between two angles with respect to the symmetry axis of the shoe, from the side of a first point located at the intersection of the symmetry axis and the inner periphery of the lower layer, these angles having as a common vertex a second point midway between the first point and a third point located at the intersection of the symmetry axis and a straight line connecting the free ends of the lateral parts of the lower layer, the angles being 40 degrees and 60 degrees respectively.

5. The equid shoe of claim 4, wherein the lower rigid layer comprises at least three indentations in the inner edge of the central part of the lower layer, the second and third being symmetrically arranged within a few degrees of the first indentation arranged on the symmetry axis (A).

6. The equid shoe of claim 1, wherein the rigid material is a pure metal or a metal alloy.

7. The equid shoe of claim 6, wherein the rigid material is an aluminium alloy.

8. The equid shoe of claim 1, wherein the elastomeric material is a thermoplastic having a hardness in a range from 40 SHORE D to 65 SHORE D.

9. The equid shoe of claim 1, wherein:
the upper layer has a thickness of 3 mm to 5 mm;
the lower layer has a thickness of 3 mm to 6 mm.

10. A manufacturing process for an equid shoe in accordance with claim 1 comprising the following stages:
three inserts constituting the lateral and central parts of the lower layer of the equid shoe are cut in a sheet of rigid material, these inserts having different shapes and substantially the same thickness,
the inserts are over-moulded by injecting the upper layer with elastomeric material, with this layer having substantially the same shape, and covering the entirety of the inserts of the lower part but having a substantially different thickness in comparison with that of the inserts of the lower part.
